(19) United States
(12) Patent Application Publication
(10) Pub. No.: US 2002/0058471 A1
(43) Pub. Date: May 16, 2002

(54) Coin sorting machine

(76) Inventors: Yushi Hino, Himeji-Shi (JP); Masaharu Tochio, Himeji-Shi (JP); Kisho Yanase, Himeji-Shi (JP); Daisuke Hoshino, Himeji-Shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/824,210

(22) Filed: Apr. 3, 2001

(30) Foreign Application Priority Data
Nov. 14, 2000 (JP) 2000-346332

(51) Int. Cl. G07D 1/00

(52) U.S. Cl. 453/56

(57) ABSTRACT

A coin sorting machine includes a coin guide structure (3) that conveys coins (C) on a passage surface (30) along a guide member (32), and a conveyor belt (43) extended so as to hold coins (C) on the passage surface (30) and capable of conveying the coins (C). An exclusion hole (60) is formed in the passage surface contiguously with the guide member. The exclusion hole has a guide side wall (60a) extending away from the guide member toward the downstream side. A support roller member (62) is disposed below the exclusion hole opposite to the conveyor belt. The support roller member can be selectively set at a coin-passing position where a top part thereof is on a level not lower than that of an upper end of the guide side wall of the exclusion hole and a coin-excluding position where the top part thereof is on a level lower than that of the upper end of the guide side wall of the exclusion hole.

### BACKGROUND OF THE INVENTION

1. Field of the Invention

The present invention relates to a coin sorting machine for sorting coins while the coins are carried along a coin carrying passage.

2. Description of the Related Art

Referring to FIGS. 4 and 5, a coin sorting machine disclosed in Jpn. Pat. No. 2557278 has a passage member 13 having a substantially horizontal passage surface, and a conveyor belt 14 for conveying coins C along the passage member 13. A coin feeder 9 provided with a coin feed disk 90 that feeds coins C one by one is disposed near the entrance end of the passage member 13.

The passage member 13 is provided with a rectangular exclusion hole 11. A rotary member 10 is disposed under the exclusion hole 11. As shown in FIG. 4, a coin identifying device 16 for identifying coins is disposed on the upstream side of the exclusion hole 11 with respect to a coin conveying direction. A coin sensor 17 that detects coins C is disposed on the passage surface at a position between the exclusion hole 11 and the coin identifying device 16.

As shown in FIG. 5, the rotary member 10 is supported for rotation about an axis parallel to the passage surface of the passage member 13 and perpendicular to the to the coin conveying direction. The rotary member 10 has a flat part 10A parallel to the axis of rotation of the rotary member 10, and a round part 10B having the shape of a part of a circular cylinder having its axis coincided with the axis of rotation of the rotary member 10. A pressure roller 15 is disposed on the conveyor belt 14 at a position corresponding to the exclusion hole 11 to press down a coin C.

The rotary member 10 is turned between a coin-passing position (FIG. 5(a))where the round part 10B of the rotary member 10 faces the exclusion hole 11 and a coin-excluding position (FIG. 5(b)) where the flat part 10A faces the exclusion hole 11 by a rotary solenoid actuator R shown in FIG. 4. FIG. 5(c) shows the rotary member 10 being turned from the coin-excluding position shown in FIG. 5(b) to the coin-passing position shown in FIG. 5(a). When the rotary member 10 is set at the coin-excluding position shown in FIG. 5(b), the flat part 10A slopes down in the coin conveying direction.

This conventional coin sorting machine performs the following operations.

(1) When the rotary member 10 is set at the coin-passing position shown in FIG. 5(a), the round part 10B of the rotary member 10 supports a coin C conveyed along the passage member 13 by the conveyor belt 14, so that the coin C does not drop through the exclusion hole 11 and is conveyed onward.

(2) When the rotary member 10 is set at the coin-excluding position shown in FIG. 5(b), a coin C conveyed along the passage member 13 by the conveyor belt 14 drops through the exclusion hole 11 onto the inclined flat part 10A of the rotary member 10 and slides down along the flat part 10A.

This coin sorting machine has the following problems. As shown in FIG. 5(a), after a leading end part of the coin C moving on the rotary member 10 set at the coin-passing position has moved beyond the downstream side wall of the exclusion hole 11, the coin C is held between the passage surface of the passage member 13 and the conveyor belt 14. However, if the rotary member 10 is turned to the coin-excluding position at this point, the highest part of the rotary member 10 supporting the coin C moves upstream as shown in FIG. 5(b). Therefore, if timing of turning the rotary member 10 from the coin-passing position to the coin-excluding position is excessively early, the coin C is unable to pass the exclusion hole 11 successfully. Such a restricting condition on the timing of changing the position of the rotary member 10 has been an impediment to the enhancement of coin sorting rate.

A coin being conveyed in the coin conveying direction either passes straight across the exclusion hole 11 or drops straight through the exclusion hole 11, in plane view. Therefore, the difference between the diameter of the smallest coin that is able to pass across the exclusion hole 11 with the rotary member 10 set at the coin-passing position shown in FIG. 5(a) and that of the largest coin that is able to drop through the exclusion hole 11 with the rotary member 10 set at the coin-excluding position shown in FIG. 5(b) cannot be large. Thus, the conventional coin sorting machine is capable of sorting only coins of different diameters in a narrow diameter range.

### SUMMARY OF THE INVENTION

The present invention has been made in view of such a problem and it is therefore an object of the present invention to provide a coin sorting machine capable of sorting coins at a high sorting rate higher than that at which the conventional coin sorting machine sorts coins and of sorting coins of different diameters in a wide diameter range.

To achieve the object, the present invention provides a coin sorting machine comprising: a coin guide structure including a passage member having a substantially horizontal passage surface and provided with an exclusion hole, and a guide member extended on the passage surface to guide coins from an upstream side to a downstream side of the passage member along the passage surface; a conveyor belt extended so as to hold coins on the passage surface of the passage member and capable of conveying coins from the upstream side to the downstream side of the passage member along the guide member; and a support roller member disposed below the exclusion hole opposite to the conveyor belt; wherein the exclusion hole is formed in the passage member contiguously with the guide member, and has a guide side wall extending obliquely away from the guide member toward the downstream side of the passage member; and wherein the support roller member can be selectively set at a coin-passing position where a top part thereof is on a level not lower than that of the upper end of the guide side wall of the exclusion hole and a coin-excluding position where a top part thereof is on a level lower than that of the upper end of the guide side wall of the exclusion hole.

The coin sorting machine according to the present invention performs the following operations.

(1) When the support roller member is set at the coin-passing position, a coin being conveyed on the passage surface along the guide member is held between the top part of the support roller member and the conveyor belt and passes the exclusion hole without dropping through the same.

(2) When the support roller member is set at the coin-excluding position, a leading end part of a coin being conveyed on the passage surface along the guide member drops into the exclusion hole onto the top part of the support roller member and the peripheral edge of the coin comes into contact with the guide side wall of the exclusion hole. Then the coin moves along the guide side wall away from the guide member toward the downstream side of the passage member. Finally, the coin separates from the support roller member obliquely laterally and drops through the exclusion hole.

Thus, the coin being conveyed in the coin conveying direction separates from the support roller member obliquely laterally instead of dropping straight along the support roller member, in plane view. Therefore, the coin to be excluded can be separated from the support roller member in an early timing and hence the timing of moving the support roller member from the coin-excluding position to the coin-passing position can be advanced.

When the support roller member is set at the coin-passing position, the coin is held between the passage surface and the conveyor belt after a part of the coin on the side of the guide member past the guide side wall of the exclusion hole and arrived upon the passage surface. Thus, the held coin does not drop through and passes the exclusion hole even if the support roller member is turned to the coin-excluding position and only the following coin drops through the exclusion hole.

Thus, coins can be surely sorted even if the support roller member is turned between the coin-passing position and the coin-excluding position in an early timing, so that coin sorting machine is capable of sorting coins at a high coin sorting rate higher than that of the conventional coin sorting machines.

A coin to be conveyed forward is moved straight past the exclusion hole while a coin to be excluded is moved obliquely laterally from the support roller member and is made to drop. Therefore, the difference between the diameter of the smallest coin that can be moved past the exclusion hole with the support roller member set at the coin-passing position and that of the largest coin that can be dropped through the exclusion hole with the support roller member set at the coin-excluding position is large. Thus the coin sorting machine of the present invention is capable of sorting coins of different diameters included in a diameter range wider than that including the diameters of coins that can be sorted by the conventional coin sorting machine.

In the coin sorting machine of the present invention, the support roller member may include: a shaft supported for rotation with its axis extended substantially in parallel to the passage surface and substantially perpendicularly to the coin conveying direction; an eccentric member eccentrically mounted on the support shaft and having a large-radius part and a small-radius part; and a free roller mounted for rotation on a periphery of the eccentric member. The height of the free roller with respect to the passage surface can be changed by turning the support shaft. Thus the free roller can be moved between the coin-passing position where the large-radius part of the eccentric member is turned upward and the coin-excluding position where the small-radius part of the eccentric member is turned upward.

The coin sorting machine of the present invention may further comprise a coin identifying device disposed in the coin guide structure at a position on the upstream side of the exclusion hole with respect to the coin conveying direction to identify coins; and a controller that selectively sets the support roller member at the coin-passing position and the coin-excluding position, according to an identification of coins by the coin identifying device. Thus, coins can be sorted by selectively setting the support roller member at the coin-passing position and the coin-excluding position, according to the identification of the coins by the coin identifying device.

The coin sorting machine of the present invention may further comprise a pressure roller disposed so as to press a coin through the conveyor belt against the support roller member. The pressure roller ensures securely holding the coin between the support roller member and the conveyor belt.

### BRIEF DESCRIPTION OF THE DRAWINGS

FIG. 1 is a plan view of an essential part of a coin sorting machine in a preferred embodiment according to the present invention;

FIG. 2a is an enlarged plan view of an essential part of the coin sorting machine shown in FIG. 1 in a coin-passing operation;

FIG. 2b is a longitudinal sectional view of the essential part of the coin sorting machine shown in FIG. 1;

FIG. 3a is an enlarged plan view of an essential part of the coin sorting machine shown in FIG. 1 in a coin-excluding operation;

FIG. 3b is a longitudinal sectional view of the essential part of the coin sorting machine shown in FIG. 3a;

FIG. 4 is a plan view of an essential part of a conventional coin sorting machine; and

FIGS. 5 shows longitudinal sectional views of the coin sorting machine shown in FIG. 4 in (a) a coin-passing operation, (b) a coin-excluding operation and (c) a returning operation returning from a state for the coin-excluding operation to a state for the coin-passing operation.

### DESCRIPTION OF THE PREFERRED EMBODIMENTS

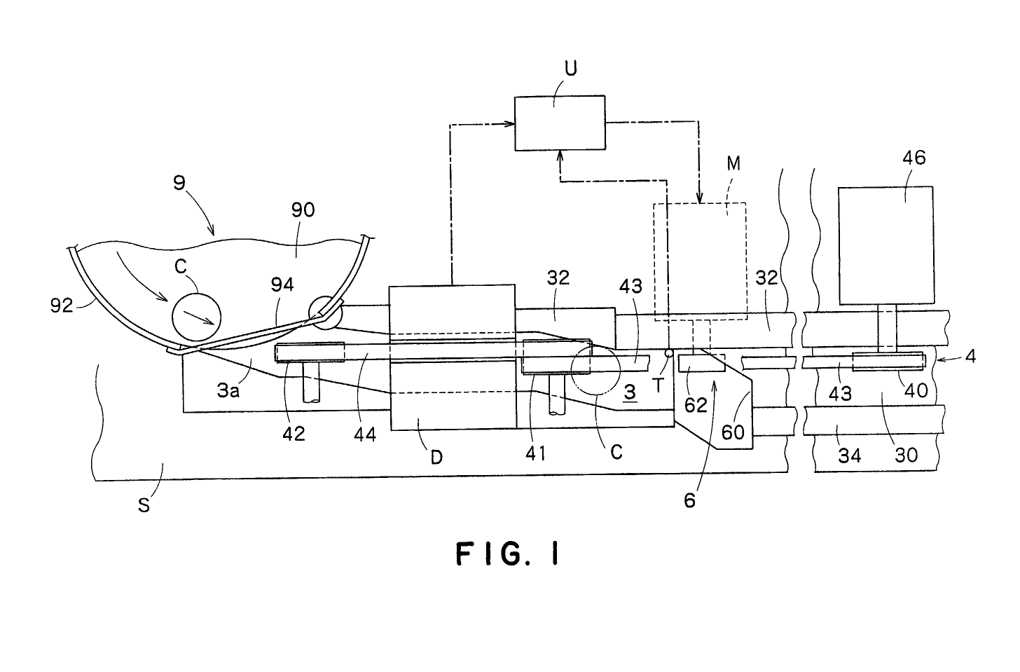

The construction, operations and effects of a coin sorting machine in a preferred embodiment according to the present invention and modifications of the same will be described with reference to FIGS. 1 to 3b.

General Construction

Referring to FIG. 1, a coin sorting machine in a preferred embodiment according to the present invention has a coin guide structure 3 forming a passage for substantially horizontally guiding coins C being conveyed one by one from its upstream side toward its downstream side. A conveying device 4 for conveying coins C from the upstream side toward the downstream side of the coin guide structure 3 is disposed on the coin guide structure 3. A coin sorting part 6 for sorting coins C is disposed in the coin guide structure 3. A coin identifying device D is disposed in the coin guide structure 3 at a position on an upstream side of the coin sorting part 6 with respect to the coin conveying direction. A coin feeder 9 for feeding coins C to the coin guide structure 3 is disposed near the entrance 3a of the coin guide structure 3.

The coin guide structure 3 is formed on a base plate S on which the coin sorting machine is installed. The coin guide structure 3 has a guide member 32 and a side member 34, which are extended on the base plate S. The guide member 32 and the side member 34 define a passage surface 30 on the surface of the base plate S. A part of the base plate S corresponding to the passage surface 30 forms a passage base plate (passage member). Although the coin guide structure 3 is substantially straight, a diagonal section is formed in the coin guide structure 3 between the coin identifying device D and the coin sorting part 6. Thus, peripheries of coins being conveyed along the coin guide structure 3 slide along the guide member 32.

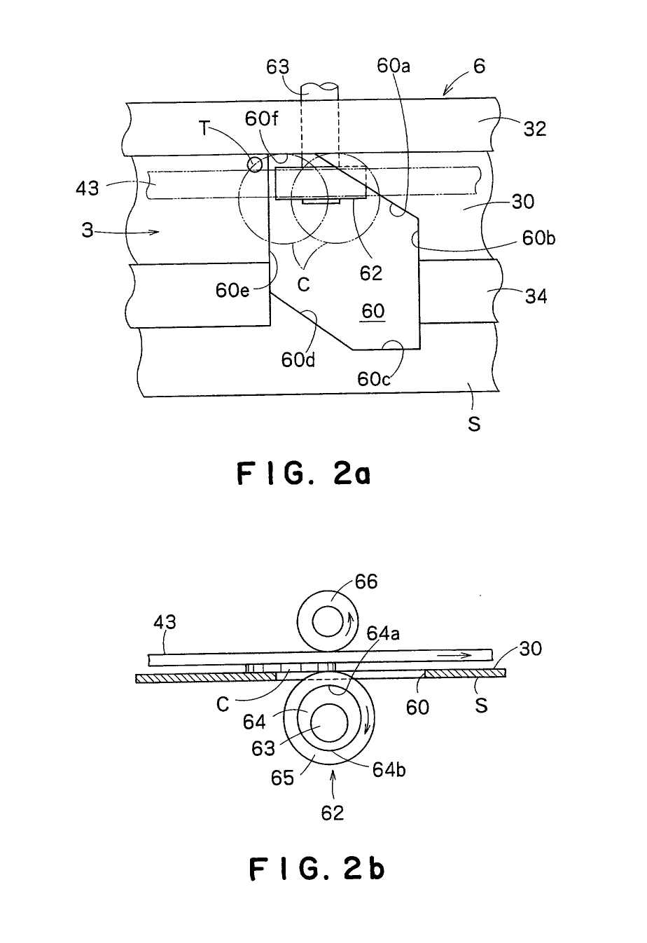

The conveying device 4 has pulleys 40, 41 and 42 disposed near an exit at the right end, as viewed in FIG. 1, in the diagonal section 36 and near the entrance 3a of the coin guide structure 3, respectively. Conveyor belts 43 and 44 are extended between the pulleys 40 and 41 and between the pulleys 41 and 42, respectively. The pulley 40 is driven for rotation by a motor 46. The conveyor belts 43 and 44 are positioned to the side of the guide member 32 along which coins C slide. The conveyor belts 43 and 44 pressed against the upper surfaces of coins C so that the coins C are conveyed while sliding along the passage surface 30 as shown in FIG. 2b.

The coin feeder 9 has a rotating feed disk 90. A thickness restriction plate 94 is disposed above the feed disk 90 beside the entrance 3a of the coin guide structure 3. The thickness restriction plate 94 is designed to separate superposed coins C so that the coins C are fed one by one into the coin guide structure 3. The periphery of the feed disk 90 excluding a section corresponding to the thickness restriction plate 94 is covered with a wall 92.

The coin identifying device D shown in FIG. 1 may be a known coin identifying device that magnetically discerns the material of a coin or optically recognizes an image, such as a relief image, of a coin. The coin identifying device D gives an identification signal to the control unit (controller) U.

Coin Sorting Part

The construction of the coin sorting part 6 will be concretely described with reference to FIGS. 1 to 3b.

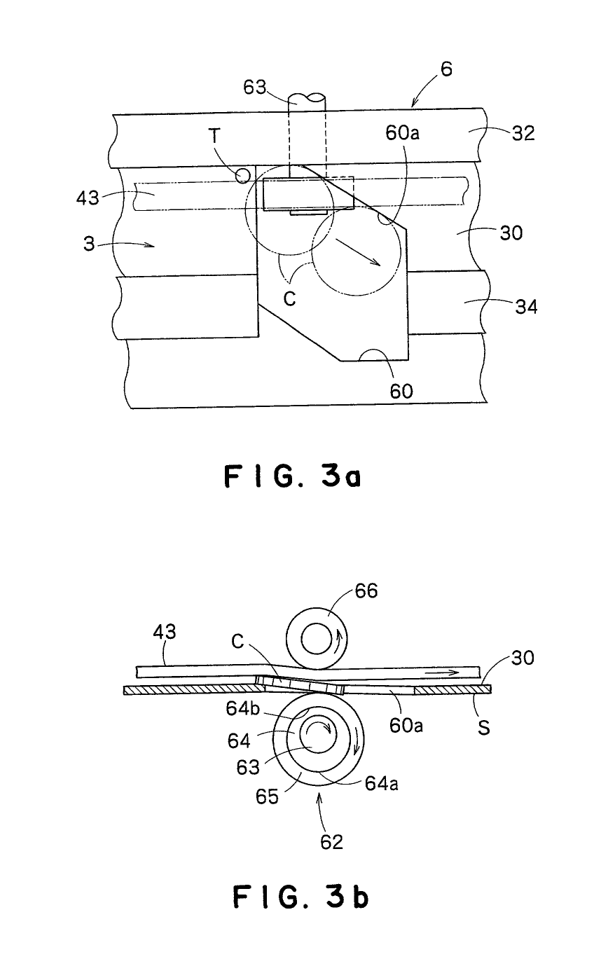

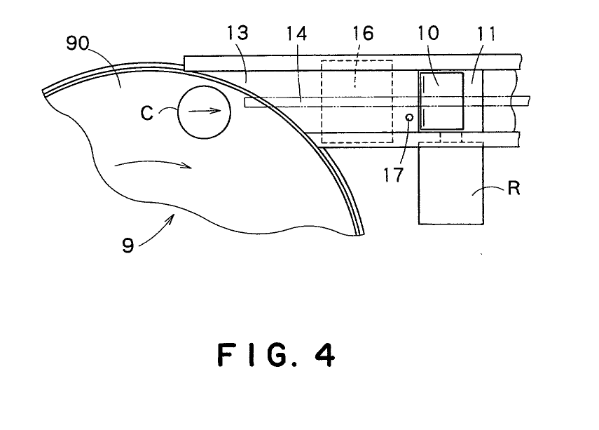

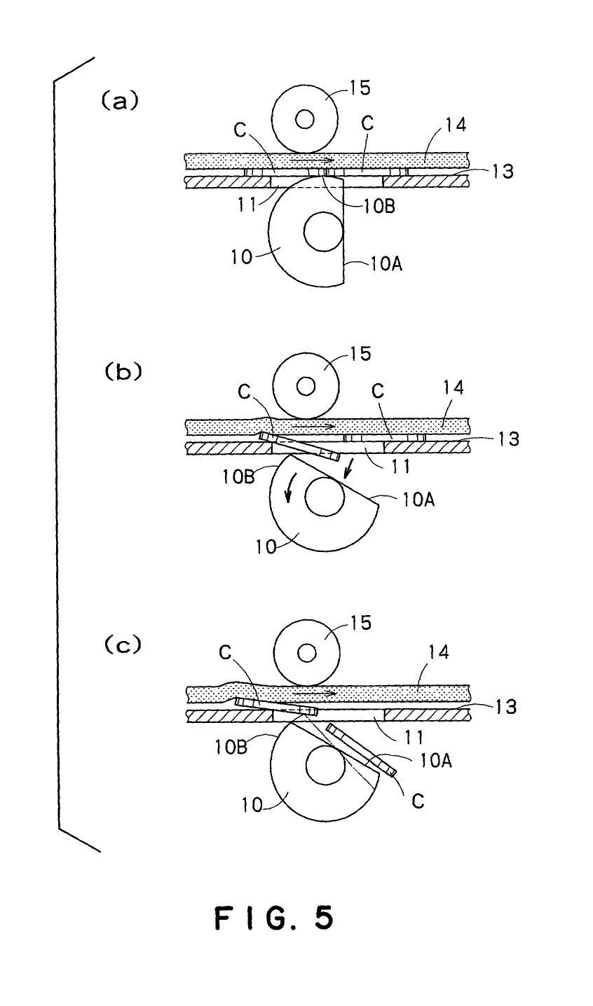

Referring to FIGS. 2a to 3b, the coin sorting part 6 includes a part of the base plate S (FIG. 1) provided with an exclusion hole 60, a support roller member 62 and a pressure roller 66. The support roller member 62 and the pressure roller 66 are disposed on the lower side and the upper side of the base plate S, respectively, corresponding to the exclusion hole 60. The exclusion hole 60 extends laterally outward from a part of the guide surface 30 contiguous with the inner side of the guide member 32 beyond the side member 34, cutting off the side member 34.

As shown in FIG. 2a, the exclusion hole 60 has a hexagonal shape defined by a guide side wall 60a, a downstream side wall 60b, an outer side wall 60c, a counter side wall 60d, a upstream side wall 60e and an inner side wall 60f. The guide side wall 60a and the counter side wall 60d, the downstream side wall 60b and the upstream side wall 60e, and the outer side wall 60c and the inner side wall 60f are parallel to each other, respectively. The inner side wall 60f coincides with the inner side of the guide member 32.

The guide side wall 60a extends straight, and is inclined at an angle of about 300 to the inner side of the guide member 32 so as to extend away from the guide member 32 toward the downstream side to a middle part with respect to width of the passage surface 30. The upstream side of the guide side wall 60a on the side of the guide member 32 is disposed at a position corresponding to the axis of the support roller member 62.

A coin sensor T for detecting a coin C is disposed immediately behind the upstream side wall 60e of the exclusion hole 60 to recognize the arrival and/or the passage of a coin C at the coin sensor T. Signals provided by the coin sensor T are given to the control unit U shown in FIG. 1.

As shown in FIG. 2b, the support roller member 62 has a support shaft 63, an eccentric bearing (eccentric member) 64 and a ring-shaped free roller 65. The support roller member 62 can be moved between a coin-passing position where a top part thereof is located on a level not lower than that of the upper edge of the guide side wall 60a, which is flush with the passage surface 30, and a coin-excluding position where a top part thereof is located on a level lower than that of the upper edge of the guide side wall 60a.

More concretely, the eccentric bearing 64 fastened to the support shaft 63 is turned by a stepping motor M (FIG. 1). When a large-radius part 64a of the eccentric bearing 64 is turned upward, the support roller member 62 is set at the coin-passing position (FIG. 2b). When a small-radius part 64b of the eccentric bearing 64 is turned upward, the support roller member is set at the coin-excluding position (FIG. 3b). The stepping motor M is controlled by a drive signal provided by the control unit U (FIG. 1).

The free roller 65 is mounted on the periphery of the eccentric bearing 64 for free rotation. The pressure roller 66 is supported for free rotation so as to apply pressure to the conveyor belt 43 to hold a coin C between the conveyor belt 43 and the support roller member 62 when the support roller member 62 is set at the coin-passing position as shown in FIG. 2b.

Preferably, a top part of the support roller member 62, i.e., a top part of the free roller 65, is on a level slightly above that of the upper edge of the guide side wall 60a of the exclusion hole 60 (flush with the passage surface 30) when the support roller member 62 is set at the coin-passing position as shown in FIG. 2b.

The periphery of a coin C must be able to come into contact with the guide side wall 60a of the exclusion hole 60 when the coin C is brought onto the top part of the support roller member 62 set at the coin-excluding position as shown in FIG. 3b. Although dependent on the thickness of the coin C, theoretically the top part of the support roller member 62 must be on a level lower than that of the upper edge of the guide side wall 60a of the exclusion hole 60. However, it is preferable that the top part of the support roller member 62 is on a level slightly below that of the lower edge of the guide side wall 60a as shown in FIG. 3b in view of surely bringing the periphery of the coil C into contact with the guide side wall 60a of the exclusion hole 60.

Operation and Effect

Referring to FIG. 1, coins C supplied to the coin feeder 9 is fed past the thickness restriction plate 94 one by one into the coin guide structure 3 as the coin feed disk 90 rotates. The coin C fed to the coin guide structure 3 is conveyed by the conveying device 4 toward the downstream side of the coin guide structure 3. The coin identifying device D identifies the coin C. The support roller member 62 is selectively set at the coin-passing position and the coin-excluding position for sorting, depending on an identification of coins by the coin identifying device D.

(1) When the support roller member 62 is set at the coin-passing position as shown in FIGS. 2a and 2b, the coin C being conveyed by the conveyor belt 43 through the coin guide structure 3 along the guide member 32 is held between the conveyor belt 43 and the support roller member 62 and pressed through the conveyor belt 43 against the support roller member 62 by the pressure roller 66 and is move across the exclusion hole 60 without dropping through the exclusion hole 60.

(2) When the support roller member 62 is set at the coin-excluding position as shown in FIGS. 3a and 3b, a leading end part of the coin C being conveyed by the conveyor belt 43 through the coin guide structure 3 along the guide member 32 drops in the exclusion hole 60 onto the top of the support roller member 62 and the periphery of the coin C comes into contact with the guide side wall 60a of the exclusion hole 60. Then, the coin C is guided by the guide side wall 60a so as to move away form the guide member 32 toward the downstream side. Finally, the coin C is separated obliquely laterally from the support roller member 62 and drops through the exclusion hole 60. Thus, the coin C is excluded.

Thus, the coin C is dropped by obliquely laterally moving the coin C to separate the coin C from the support roller member 62 instead of by moving the coin C straight along the support roller member 62, in plane view. Thus the coin C to be excluded can be separated from the support roller member 62 in an early timing and hence the support roller member 62 can be returned to the coin-passing position in early timing.

The coin C passing the support roller member 62 set at the coin-passing position is held between the passage surface 30 and the conveyor belt 43 after a peripheral part of the coin C sliding along the guide member 32 has passed the guide side wall 60a of the exclusion hole 60 and has moved onto a part of the passage surface 30 at a downstream side of the exclusion hole 60 with respect to the coin conveying direction. Even if the support roller member 62 is set at the coin-excluding position at this stage, the coin C will not drop through the exclusion hole 60; the coin C moves across the exclusion hole 60 and only the following coin C drops through the exclusion hole 60.

Thus, coins can be surely sorted even if the position of the support roller member 62 is changed between the coin-passing position and the coin-excluding position inearly timing, sothat coins can be sorted at a high sorting rate higher than that of the conventional coin sorting machine.

A coin to be conveyed forward is moved straight past the exclusion hole while a coin to be excluded is moved obliquely laterally from the support roller member and is made to drop. Therefore, the difference between the diameter of the smallest coin that can be moved past the exclusion hole 60 with the support roller member 62 set at the coin-passing position and that of the largest coin that can be dropped through the exclusion hole 60 with the support roller member 62 set at the coin-excluding position is large. Thus the coin sorting machine of this preferred embodiment is capable of sorting coins of different diameters included in a diameter range wider than that including the diameters of coins that can be sorted by the conventional coin sorting machine.

When the identification device D (FIG. 1) provides an identification signal indicating a coin to be excluded, such as an unidentifiable coin or a specified coin, the coin is excluded by the following operation. The identification device D gives the identification signal indicating a coin C to be excluded to the control unit U. Upon the detection of the coin C, the coin sensor T gives a detection signal to the control unit U. Then the control unit U gives a drive signal to the stepping motor M to set the support roller member 62 at the coin-excluding position (FIG. 3b). After a predetermined time necessary for separating the coin C from the support roller member 62 has elapsed, the control unit U gives a drive signal to the stepping motor M to return the support roller member 62 to the coin-passing position (FIG. 2b).

Modifications

The coin guide structure 3 may be provided with a plurality of coin sorting devices similar to the coin sorting part 6 in series instead of the single coin sorting part 6 to increase the kinds of sortable coins.

The shape of the exclusion hole 60 is not limited to that shown in FIG. 2a; the exclusion hole 60 may be formed in any proper shape, provided that the exclusion hole 60 has the function of the guide side wall 60a and is capable of permitting coins C to be excluded to drop therethrough.

Although the coin sorting machine in this embodiment is provided with the pressure roller 66 to ensure securely holding a coin C between the support roller member 62 and the conveyor belt 43, the pressure roller 66 may be omitted if the coin C can be securely held between the support roller member 62 and the conveyor belt 43 without using the pressure roller 66.

What is claimed is:

1. A coin sorting machine comprising:
a coin guide structure including a passage member having a substantially horizontal passage surface and provided with an exclusion hole, and a guide member extended on the passage surface to guide coins from an upstream side to a downstream side of the passage member along the passage surface;
a conveyor belt extended so as to hold coins on the passage surface of the passage member and capable of conveying coins from the upstream side to the downstream side of the passage member along the guide member; and
a support roller member disposed below the exclusion hole opposite to the conveyor belt;
wherein the exclusion hole is formed in the passage member contiguously with the guide member, and has a guide side wall obliquely extending away from the guide member toward the downstream side of the passage member; and
wherein the support roller member can be selectively set at a coin-passing position where a top part thereof is on a level not lower than that of an upper end of the guide side wall of the exclusion hole and a coin-excluding position where the top part thereof is on a level lower than that of the upper end of the guide side wall of the exclusion hole.

2. The coin sorting machine according to claim 1, wherein the support roller member includes:
a shaft supported for rotation with its axis extended substantially in parallel to the passage surface and substantially perpendicularly to the coin conveying direction;
an eccentric member eccentrically mounted on the support shaft and having a large-radius part and a small-radius part; and
a free roller mounted for rotation on a periphery of the eccentric member.

3. The coin sorting machine according to claim 1 or 2 further comprising:
a coin identifying device disposed in the coin guide structure at a position on an upstream side of the exclusion hole with respect to the coin conveying direction to identify coins; and
a controller that selectively sets the support roller member at the coin-passing position and the coin-excluding position, according to an identification of coins by the coin identifying device.

4. The coin sorting machine according to claim 1 or 2 further comprising a pressure roller disposed so as to press a coin through the conveyor belt against the support roller member.
